(19) United States
(12) Patent Application Publication
(10) Pub. No.: US 2006/0226079 A1
(43) Pub. Date: Oct. 12, 2006

(54) HEMODIALYSIS APPARATUS AND METHOD FOR HEMODIALYSIS

(75) Inventors: Yoshihiro Mori, Makinohara-shi (JP); Masahiro Toyoda, Makinohara-shi (JP)

Correspondence Address: DARBY & DARBY P.C., P. O. BOX 5257, NEW YORK, NY, 10150-5257, US

(73) Assignee: Nikkiso Co. Ltd., Tokyo (JP)

(21) Appl. No.: 11/278,745

(22) Filed: Apr. 5, 2006

(30) Foreign Application Priority Data
Apr. 8, 2005 (JP) 2005-112552

(51) Int. Cl. B01D 65/00

(52) U.S. Cl. 210/646; 210/739; 210/96.2; 210/321.6; 210/85

(57) ABSTRACT

A hemodialysis apparatus includes a dialyzing device, a measuring device and a calculation device. The dialyzing device dialyzes and ultrafiltrates blood of a patient circulating extracorporeally to perform hemodialysis treatment. The measuring device measures a variation rate of a body weight of the patient and a variation rate of a predetermined blood benchmark during the hemodialysis treatment using the dialyzing device. The calculation device calculates, during the hemodialysis treatment, a parameter relating the variation rate of the body weight and the variation rate of the predetermined blood benchmark to each other, and correlating to a dry weight of the patient.

### INCORPORATION BY REFERENCE

The present application claims priority under 35 U.S.C. §119 to Japanese Patent Application No. 2005-112552 filed on Apr. 8, 2005, the entire contents of which are incorporated herein by reference.

### FIELD OF THE INVENTION

The present invention relates to a hemodialysis apparatus and method, which can perform hemodialysis and ultrafiltration by extracorporeally circulating blood of a patient.

### BACKGROUND OF INVENTION

In hemodialysis treatment, a conventional hemodialysis apparatus includes a blood circuit to extracorporeally circulate blood of a patient, a dialyzer provided at the blood circuit, a peristaltic blood pump, and a dialysis device. The dialysis device allows dialysate to flow in and out to the dialyzer from the dialysis device to perform hemodialysis and ultrafiltration. The blood circuit is provided with an arterial blood circuit having an arterial needle at an end thereof and a venous blood circuit having a venous needle at an end thereof.

When the arterial needle and the venous needle are inserted to the patient, and the blood pump is turned on, blood of the patient flows through the arterial needle into the arterial blood circuit, the dialyzer, the dialysis device, and the venous blood circuit in sequence, and then flows back into the body of the patient through the venous needle. The dialyzer includes hollow fibers forming membranes for hemodialysis. The blood flows inside of the hollow fibers. The dialysate, which has a predetermined concentration and is supplied from the dialysis device, flows outside the hollow fibers (i.e., between outside surfaces of the hollow fibers and an inside surface of a case of the dialysis device). Waste products in the blood flowing in the inside of the hollow fibers permeate into the dialysate through the membranes.

The blood flows back to the body of the patient after flowing through the arterial blood circuit and after the waste products being removed from the blood. Also, the dialysis device is provided with an ultrafiltration pump that removes water from the blood. The blood is also ultrafiltrated through the membranes during the hemodialysis treatment. A volume of water to be ultrafiltrated by the ultrafiltration pump (i.e., an ultrafiltration rate) is adjusted by controlling a driving rate of the ultrafiltration pump.

An ultrafiltration volume controlled by the ultrafiltration pump is to be set so as to make a body weight of the patient close to a dry-weight of the patient. The dry-weight is a body weight of the patient when a volume of an interstitial fluid outside of cells is properly adjusted. In this regard, the dry-weight is calculated relating various factors to each other based on experiences of a medical staff (e.g., a medical doctor). The various factors may include a cardiothoracic index, changes in blood pressures during the hemodialysis treatment, variation in blood benchmarks (e.g., a variation rate of a circulating blood volume ΔBV), the body weight of the patient measured before the hemodialysis treatment, and a decrease in the body weight during the hemodialysis treatment.

### SUMMARY OF INVENTION

In such a conventional hemodialysis apparatus as described above, because the ultrafiltration volume is determined based on the dry-weight calculated based on experiences of a medical staff, the ultrafiltration volume for each patient is not accurately determined due to differences in physique and in blood benchmarks among patients. Thus, although it is ideal to perform the ultrafiltration until the body weight of the patient equals to an accurate dry-weight of the patient, an inaccurate dry-weight tends to be set.

According to one aspect of the present invention, a hemodialysis apparatus includes a dialyzing device, a measuring device and a calculation device. The dialyzing device dialyzes and ultrafiltrates blood of a patient circulating extracorporeally to perform hemodialysis. The measuring device measures a variation rate of a body weight of the patient and a variation rate of a predetermined blood benchmark during the hemodialysis using the dialyzing device. The calculation device calculates, while the hemodialysis is performed, a parameter relating the variation rate of the body weight and the variation rate of the predetermined blood benchmark to each other, and correlating to a dry weight of the patient.

According to another aspect of the present invention, the hemodialysis method includes performing hemodialysis and ultrafiltration by extracorporeally circulating blood of a patient. A variation rate of a body weight of the patient and a variation rate of a predetermined blood benchmark are measured while the hemodialysis and the ultrafiltration are performed. During the hemodialysis treatment, a parameter are calculated. The parameters relate the variation rate of the body weight and the variation rate of the predetermined blood benchmark to each other, and correlate to a dry weight of the patient.

The parameters, which relate the variation rate of the body weight and the variation rate of the blood benchmark to each other and correlate to a dry weight of the patient, are standardized parameters applicable to more than one patient. Thus, the parameters are considered as effective benchmarks to perform in real-time effective ultrafiltration.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a schematic diagram of a hemodialysis apparatus of the present invention;

FIG. 2 is a schematic diagram of a dialysis device in the hemodialysis apparatus of the present invention, showing a mechanical structure of the dialysis device; and

FIG. 3 is a schematic diagram of the dialysis device of the present invention, showing an electrical structure of the dialysis device.

### DETAILED DESCRIPTION OF THE INVENTION

The embodiments will now be described with reference to the accompanying drawings, wherein like reference numerals designate corresponding or identical elements throughout the various drawings.

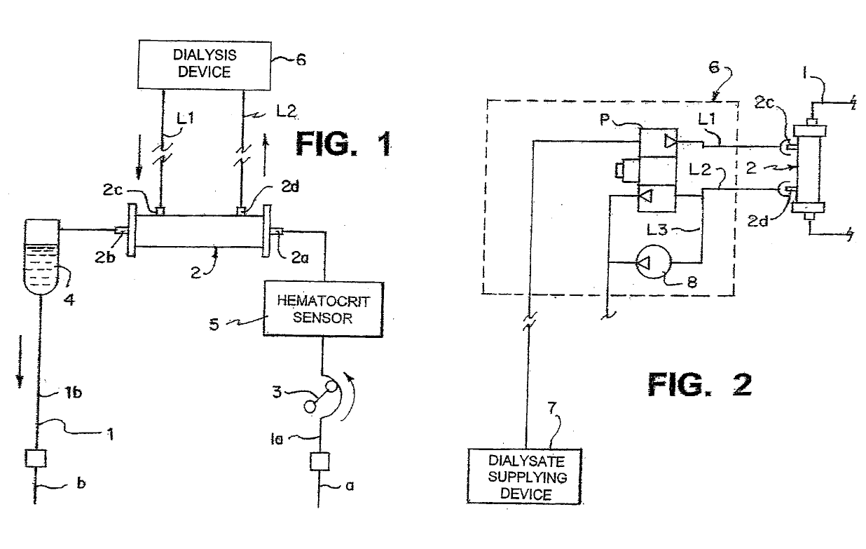

A hemodialysis apparatus according to the present invention is used to perform hemodialysis and ultrafiltration by extracorporeally circulating blood of a patient. FIG. 1 is a schematic diagram of the hemodialysis apparatus that includes a blood circuit 1, a dialyzer 2 and a dialysis device 6. As shown in FIG. 1, the blood circuit 1 is provided with an arterial blood circuit 1a and a venous blood circuit 1b each made from flexible tubing, and circulates the blood of the patient. The dialyzer 2 is connected to the blood circuit 1 between the arterial blood circuit 1a and the venous blood circuit 1b and performs hemodialysis. The dialysis device 6 is connected to the dialyzer 2 to supply dialysate and ultrafiltrate the blood.

The arterial blood circuit 1a is provided at an end thereof with an arterial needle a, and also provided therealong with a blood pump 3 and a hematocrit sensor 5. The venous blood circuit 1b is provided at an end thereof with a venous needle b, and also provided therealong with a drip chamber 4 to remove bubbles.

The hematocrit sensor 5 has a photo emitter (e.g., a light emitting diode) and a photo detector (e.g., a photo diode), and measures a hematocrit value indicating a concentration of the blood. The hematocrit sensor 5 can function by emitting a light to the blood from the photo emitter and detecting either a transmitted or reflected light by the photo detector. Specifically, the hematocrit value indicates a ratio of a volume of red cells to a volume of whole blood.

When the blood pump 3 is turned on while the arterial needle a and the venous needle b are inserted to the patient, the blood of the patient flows through the arterial blood circuit 1a into the dialyzer 2 that dialyzes the blood. Subsequently, the blood returns to the body of the patient through the venous blood circuit 1b after bubbles are removed by the drip chamber 4. Thus, the blood is dialyzed by the dialyzer 2 during extracorporeal circulation through the blood circuit 1.

The dialyzer 2 is provided with a blood inlet port 2a, a blood outlet port 2b, a dialysate inlet port 2c and a dialysate outlet port 2d. The blood inlet port 2a and the blood outlet port 2b are each connected to ends of the arterial blood circuit 1a and the venous blood circuit 1b, respectively. Additionally, a dialysate inlet line L1 and a dialysate outlet line L2 are each extended from the dialysis device 6, and each connected to the dialysate inlet port 2c and the dialysate outlet port 2d, respectively.

The dialyzer 2 includes a plurality of hollow fibers. The blood flows the inside of the hollow fibers, and the dialysate flows between outside surfaces of the hollow fibers and an inside surface of a case of the dialyzer 2. The hollow fibers are provided with a plurality of micropores on the inside and outside surfaces of the hollow fibers. This forms permeable membranes which allow waste products in the blood to permeate into the dialysate.

FIG. 2 is a schematic diagram showing a mechanical structure of the dialysis device 6 in the hemodialysis apparatus. As shown in FIG. 2, the dialysis device 6 includes a duplex pump P, a bypass line L3 and an ultrafiltration pump 8. The duplex pump P is connected to both the dialysate inlet line L1 and the dialysate outlet line L2, bridging those two lines L1 and L2. The bypass line L3 is connected to the dialysate inlet line L2 bypassing the duplex pump P, and is also connected to the ultrafiltration pump 8. The dialysate inlet line L1 is connected at one end thereof to the dialysate inlet port 2c of the dialyzer 2, and at another end thereof to a dialysate supplying device 7 that adjusts the dialysate to a predetermined concentration.

The dialysate outlet line L2 is connected at one end thereof to the dialysate outlet port 2d of the dialyzer 2, and at another end thereof to a fluid disposal device (not shown). The dialysate supplied from the dialysate supplying device 7 flows through the dialysate inlet line L1 into the dialyzer 2, then, flows through the dialysate outlet line L2 and the bypass line L3 into the fluid disposal device.

The ultrafiltration pump 8 ultrafiltrates the blood to remove water from the blood flowing in the dialyzer 2. When the ultrafiltration pump 8 is activated, a volume of the dialysate flowing out from the dialysate outlet line L2 becomes greater than a volume of the dialysate flowing in through the dialysate inlet line L1 because the duplex pump P is quantitative. Accordingly, water is removed from the blood by the difference between the volumes flowing out and flowing in. Devices other than the ultrafiltration pump 8 (e.g., a balancing chamber) may be used to ultrafiltrate the blood. Further, the duplex pump 3 and the ultrafiltration pump 8 together form a dialyzing device in the hemodialysis apparatus, which performs the hemodialysis and the ultrafiltration by extracorporeally circulating the blood of the patient.

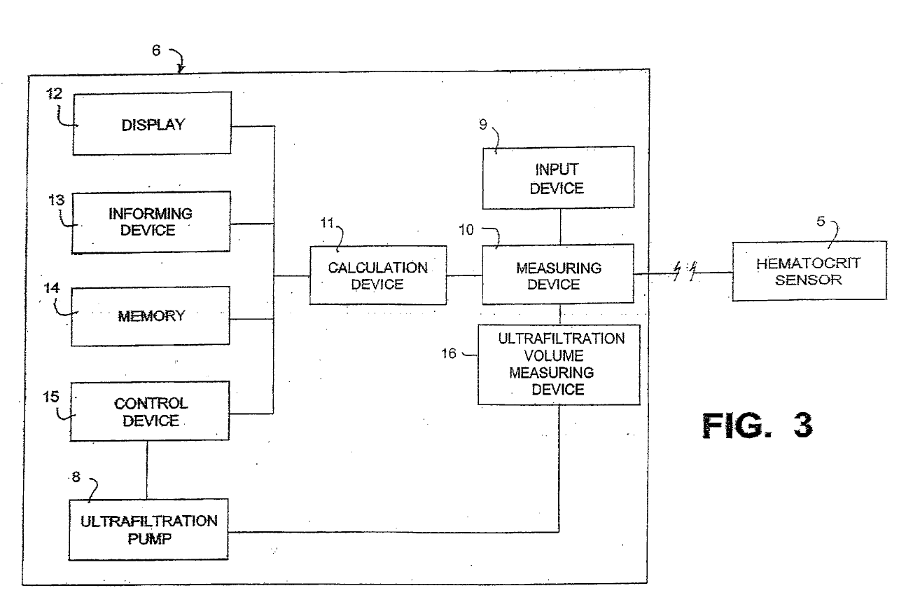

FIG. 3 is a schematic diagram showing an electrical structure of the dialysis device 6 in the hemodialysis apparatus. As shown in FIG. 3, the dialysis device 6 includes an input device 9, a measuring device 10, a calculation device 11, a display 12, an informing device 13, a memory 14, a control device 15, and an ultrafiltration volume measuring device 16. The input device 9 inputs a body weight of the patient measured before performing the hemodialysis. The informing device 13 may be a speaker to output audio signals. The ultrafiltration volume measuring device 16 measures a volume of water removed from the blood based on a driving rate of the ultrafiltration pump 8.

The measuring device 10 measures a variation rate of the body weight of the patient, and a variation rate of a circulating blood plasma volume as a predetermined blood benchmark. The measuring device 10 is electrically connected to the input devices 9 and the control device 15 and the hematocrit sensor 5. Specifically, ΔBW %, representing the variation rate of the body weight, is obtained by the following Formula 1.

$$Formula 1 \text{:}$$

$$\begin{matrix} Δ BW \% = ( BW 2 - BW 1 ) / BW 1 \times 100 \% \\ = ( - UFV ) / BW 1 \times 100 \%\end{matrix}$$

In the Formula 1, BW1 represents a body weight of the patient measured before hemodialysis, which is input by the input device 9; UFV represents an ultrafiltration volume obtained by the ultrafiltration volume measuring device 16 based on the driving rate of the ultrafiltration pump 8, which is an accumulated ultrafiltration volume at the time of measuring by the measuring device 10; and BW2 represents the body weight at the time of measuring the variation rate of the body weight. It is noted that increases and decreases of the body weight due to, for example, intake of food and excretion by the patient are disregarded.

Further, ΔCPV %, representing the variation rate of the circulating blood plasma volume as the predetermined blood benchmark, is obtained by the following Formula 2.

$$Formula 2 \text{:}$$

$$\begin{matrix}Δ CPV 1 \% = ( CPV 2 - CPV 1 ) / CPV 1 \times 100 \\ = \{ BV 2 ( 1 - Ht 2 / 100 ) - BV 1 ( 1 - Ht 1 / 100 ) \} / \\ \{ BV 1 ( 1 - Ht 1 / 100 ) \} \times 100 \\ = ( BV 2 - BV 1 - BV 2 \times Ht 2 / 100 + BV 1 \times Ht 1 / 100 ) / \\ \{ BV 1 ( 1 - Ht 1 / 100 ) \} \times 100\end{matrix}$$

In the Formula 2, Ht1% represents a hematocrit value measured by the hematocrit sensor 5 at the time the ultrafiltration is started; and Ht2% represents a hematocrit value at the time of measuring the variation rate of the circulating blood plasma volume.

Also, in the Formula 2, CPV1 and BV1 represent a volume of circulating blood plasma and a volume of circulating blood, respectively, at the time the ultrafiltration is started; and CPV2 and BV2 represent a volume of the circulating blood plasma and a volume of the circulating blood, respectively, at the time of measuring the variation rate of the circulating blood plasma volume. When the blood 1 L is defined to be equal to 1 kg, CPV1 and CPV2 are expressed as the following Formulas 3 and 4, respectively.
CPV1=BV1×(1−Ht1/100) Formula 3
CPV2=BV2×(1=Ht2/100) Formula 4

In this regard, because red blood cells in the circulating blood are not reduced in volume during the hemodialysis, and the volume is thus consistent, BV1×Ht1 equals to BV2×Ht2, both of which indicate the volume of red blood cells in the volume of the circulating blood volume. Accordingly, the above Formula 2 is also expressed as follows:

$$\begin{matrix}Δ CPV 1 \% = ( BV 2 - BV 1 ) / \{ BV 1 ( 1 - Ht 1 / 100 ) \} \times 100 \\ = ( BV 2 / BV 1 - 1 ) / ( 1 - Ht 1 / 100 ) \times 100 \\ = ( Ht 1 / Ht 2 - 1 ) / ( 1 - Ht 1 / 100 ) \times 100 \%\end{matrix}$$

According to the Formulas 1 and 2 above, the variation rate of the body weight ΔBW % and the variation rate of the circulating blood plasma volume ΔCPV % are measured by the measuring device 10. Those variation rates are transmitted to the calculation device 11 to perform a predetermined calculation to obtain a parameter PWI that is described below.

The calculation device 11 successively calculates parameters relating the variation rate of the body weight and the variation rate of the circulating blood plasma volume (i.e., the variation rate of the blood benchmark) to each other, both of which are measured by the measuring device 10, and correlating to a dry weight of the patient. As a parameter to be calculated, an index PWI indicating an effect of the variation of the body weights (i.e., decrease) due to the ultrafiltration on the blood concentration. It is noted that, when the calculation device 11 successively calculates the PWI, more than one calculation is performed from a start to an end of the hemodialysis treatment. Such calculations may be performed in predetermined interval. Further, calculation of the PWI by the calculation device 11 may be performed only once during the hemodialysis treatment. For example, the PWI calculated once at the end of the hemodialysis allows to confirm in real-time whether the body weight is reached to the dry-weight by the hemodialysis.

Further, the PWI is calculated by the formula: PWI=ΔCPV %/ΔBW %, where the variation rate of the circulating blood plasma volume ΔCPV % is divided by the variation of the body weight ΔBW %. Therefore, it is known that it is within an optimal range when the body weight reaches to the dry-weight. Thus, a greater value of the PWI indicates a greater value of the blood concentration rate in relation to decrease in the body weight due to the ultrafiltration, thereby making possible to recognize that an interstitial fluid is not supplemented to outside of blood vessels although water is removed from the blood by the ultrafiltration. In contrast, a smaller value of the PWI makes possible to recognize that there is enough of the interstitial fluid in the outside of blood vessels although water is removed from the blood by the ultrafiltration. It is noted that the optimal value of the PWI may vary, and that the optimal value of the PWI at the end of the hemodialysis may vary depending on conditions of the hemodialysis.

The display 12 may be a display provided with the dialysis device 6, and displays the parameters PWI, which are calculated by the calculation device 11. The parameters PWI are displayed in a graph (e.g., a line graph) to show changes in a time-course. Accordingly, the display 12 makes possible for a medical staff (e.g., a medical doctor) to decide in real-time whether the ultrafiltration is optimally performed, and to efficiently optimize the ultrafiltration during the hemodialysis treatment.

In addition, because the parameters PWI are graphically displayed to show changes in a time-course, it makes possible for the medical staff to visually understand changes and a trend of the changes of the parameters to further optimize the ultrafiltration during the hemodialysis. Although the display 12 graphically displays the parameters PWI according to the above-described embodiment, the display 12 may digitally display in real-time values of the parameters PWI calculated successively.

Moreover, prior to the hemodialysis treatment, when a target value of the ultrafiltration volume UFV is set, the body weight prior to the hemodialysis treatment is input into the input device 9, and the optimal range (e.g., 2 to 5) of the parameters PWI at the end of hemodialysis treatment is set, Ht2 at the end of the hemodialysis treatment is predicted by a reverse calculation when Ht1 is measured after starting measuring the blood benchmark. Accordingly, based on changes in the blood benchmarks, the medical staff effectively determines whether it is possible to comfortably perform the hemodialysis to the patient, so as to optimize the hemodialysis.

The informing device 13 informs the medical staff of the parameters PWI, which are calculated by the calculation device 11, indicating out of the optimal range. The informing device 13 may be a speaker or a light source (e.g., LED) emitting a light. The optimal range is to be set in advance by inputting into, for example, an input device of the dialysis device 6. The optimal range is a range of ideal parameters in relation to a target dry weight in the hemodialysis treatment.

The control device 15 controls the dialyzing device (e.g., the ultrafiltration pump 8 according to the above-described embodiment) to set the parameters PWI within the optimal range when the parameters PWI, calculated by the calculation device 11, indicate out of the optimal range. Specifically, when the parameters PWI indicate out of the optimal range, the control device 15 controls the ultrafiltration pump 8 to adjust an ultrafiltration rate, thereby having the parameters PWI reach within the optimal range and then ending the hemodialysis treatment.

The memory 14 memorizes the parameters PWI calculated by the calculation device 11, and includes a memory provided at the dialysis device 6. The parameters or changes thereof in a time-course, which are memorized in the memory 14, are displayed during, for example, another hemodialysis treatment (a hemodialysis treatment for the patient following the prior treatment or a hemodialysis treatment for another patient), or displayed before or after the hemodialysis treatment. For example, by displaying the parameters PWI of the same patient during a hemodialysis treatment following the prior hemodialysis treatment, the medical staff is allowed to study a trend of a mid-term or long-term treatment and current conditions of the treatment. Also, by displaying the parameters during the hemodialysis treatment for another patient, the medical staff is allowed to study the difference in indication between patients. Further, by displaying the parameters before or after the hemodialysis treatment (e.g., while the patient is waiting for the treatment lying on a bed near the hemodialysis apparatus before a needle is inserted, or until the patient leaves the bed after the needle is pulled off), the medical staff is allowed to explain to the patient current indications of the result of the treatment in comparison to prior indications.

Furthermore, during the hemodialysis treatment on the patient, when the parameters PWI of the patient, stored in memory 14, and the current parameters PWI calculated by the calculation device 11 are together displayed on the display 12, the medical staff is allowed to analyze current conditions in relation to the optimal range of the parameters PWI so as to allow effective hemodialysis treatment.

Further, the hemodialysis apparatus may be provided with a guidance function that guides the medical staff to provide an effective treatment plan based on the current conditions analyzed as described above. In this regard, when the parameters PWI are lower than the optimal range at the end of the current hemodialysis treatment, it is preferable to give a guidance to increase a volume of the ultrafiltration at the following hemodialysis treatment. Further, a data memorized in the memory 14 may be transmitted to an external terminal of the dialysis device 6 through, for example, a network, and the external terminal may be made capable of memorizing and displaying the data, and comparing it to a related data, so as to effectively share data of patients and centralize a management of a database of the data of the patients.

According to the above-described embodiment, the calculation device 11 calculates in real-time the parameters PWI relating the variation rate of the body weight and the variation rate of the blood benchmark to each other, and correlating to a dry weight of the patient, thereby eliminating necessity of manual calculation. In addition, the display of the parameters PWI in real-time makes possible to analyze in real-time the conditions of the patient during the hemodialysis treatment, to determine appropriate conditions of the treatments, to predict changing and future conditions of the patient, and to confirm treatment results and effects.

Further, because the hemodialysis apparatus is provided with devices, such as the input devices 9 and a sensor (e.g., the hematocrit sensor 5), which obtain all information necessary to calculate the parameters PWI, and provided with a display to display the parameters PWI, manufacturing costs of the hemodialysis apparatus are reduced.

The present invention is not limited to the above-described embodiments. For example, other parameters different from the parameters PWI may be used as long as those other parameters are calculated during the hemodialysis treatment to relate the variation rate of the body weight and the variation rate of the blood benchmark to each other, and correlate to a dry weight of the patient. The variation rate of the blood benchmark is not limited to the variation rate of the circulating blood plasma volume.

Further, when parameters are calculated based on the variation rate of the circulating blood plasma volume as the variation rate of the blood benchmark, a blood benchmark other than the hematocrit value (e.g. a value indicating a hemoglobin concentration and a blood serum total protein concentration) may be used. In this regard, because hemoglobin refers to a pigment in red blood cells, the hemoglobin concentration is in correlation with the hematocrit value. Further, when protein in some amount leaks out to the dialysate in the dialyzer during the hemodialysis, the protein leaked is considered within a range of measurement error. Therefore, the blood serum total protein concentration may be used to measure the variation rate of the circulating blood plasma volume as the blood benchmark. Also, the hemoglobin concentration and the blood serum total protein concentration may be measured utilizing optical devices or ultrasonic devices.

Further, with regard to disturbance elements affecting on the variation rate of the body weight and the variation rate of the blood benchmark (e.g., changes in concentrations of the dialysate, changes in blood temperatures, changes in blood flow rates, a supplemental fluid, a high sodium fluid, intake of a drug affecting on the blood, intake of food, excretion, a supplemental fluid affecting on the body weight), the hemodialysis apparatus may be provided with a device to input or store such disturbance elements, a device to inform a detection of any one of the disturbance elements, or a device to suspend or adjust calculation of parameters taking into account any one of the disturbance elements.

The present invention may be applied to other embodiments of the hemodialysis apparatus and methods for hemodialysis, which calculate in real-time, during hemodialysis treatment, a parameter relating the variation rate of the body weight and the variation rate of the blood benchmark to each other, and correlating to the dry weight of the patient, with or without the additional devices described above.

Obviously, numerous modifications and variations of the present invention are possible in light of the above teachings. It is therefore to be understood that within the scope of the appended claims, the invention may be practiced otherwise than as specifically described herein.

What is claimed is:

1. A hemodialysis apparatus comprising:
a dialyzing device configured to dialyze and ultrafiltrate blood of a patient circulating extracorporeally to perform hemodialysis treatment;
a measuring device configured to measure a variation rate of a body weight of the patient and a variation rate of a predetermined blood benchmark during the hemodialysis treatment using the dialyzing device; and
a calculation device configured to calculate, during the hemodialysis treatment, a parameter relating the variation rate of the body weight and the variation rate of the predetermined blood benchmark to each other, and correlating to a dry weight of the patient.

2. The hemodialysis apparatus of claim 1, wherein:
the variation rate of the body weight is obtained based on an ultrafiltration volume and the body weight measured before the hemodialysis treatment; and
the variation rate of the predetermined blood benchmark is obtained based on a concentration of the blood circulating extracorporeally.

3. The hemodialysis apparatus of claim 2, wherein the variation rate of the predetermined blood benchmark is a variation rate of a circulating blood plasma volume of the blood circulating extracorporeally, calculated by the calculation device based on the concentration of the blood.

4. The hemodialysis apparatus of claim 1, further comprising:
a display configured to display the parameter calculated by the calculation device.

5. The hemodialysis apparatus of claim 4, wherein the display graphically displays changes in a time-course of parameters calculated by the calculation device.

6. The hemodialysis apparatus of claim 1, further comprising:
an informing device configured to set an optimal range of the parameter and to inform a medical staff of the parameter when the parameter indicates out of the optimal range.

7. The hemodialysis apparatus of claim 1, further comprising;
a control device configured to set an optimal range of the parameter and to control the hemodialysis apparatus to work within the optimal range when the parameter indicates out of the optimal range.

8. The hemodialysis apparatus of claim 1, further comprising:
a memory configured to store either parameters calculated by the calculation device or changes in a time-course of the parameters which are displayed either during another hemodialysis treatment, or before or after the hemodialysis treatment.

9. The hemodialysis apparatus of claim 8, wherein the memory is connected to an external terminal and transmits the parameters to the external terminal.

10. The hemodialysis method, comprising the steps of:
performing hemodialysis and ultrafiltration for hemodialysis treatment by extracorporeally circulating blood of a patient;
measuring a variation rate of a body weight of a patient and a variation rate of a predetermined blood benchmark during the hemodialysis and the ultrafiltration; and
calculating, during the hemodialysis treatment, a parameter relating the variation rate of the body weight and the variation rate of the predetermined blood benchmark to each other, and correlating to a dry weight of the patient.

11. The hemodialysis method of claim 10, wherein the calculating step comprises the steps of:
obtaining the variation rate of the body weight based on an ultrafiltration volume and the body weight measured before the hemodialysis treatment; and
obtaining the variation rate of the predetermined blood benchmark based on a concentration of the blood circulating extracorporeally.

12. The hemodialysis method of claim 11, wherein the calculating step further comprises the step of calculating by the calculation device a variation rate of a circulating blood plasma volume of the blood circulating extracorporeally, based on the concentration of the blood, as the variation rate of the predetermined blood benchmark.

13. The hemodialysis method of claim 10, further comprising the step of:
displaying the parameter calculated by the calculating step.

14. The hemodialysis method of claim 13, wherein the displaying graphically displays changes in a time-course of parameters calculated by the calculating step.

15. The hemodialysis method of claim 10, further comprising the steps of:
setting an optimal range of the parameter; and
informing a medical staff of the parameter when the parameter indicates out of the optimal range.

16. The hemodialysis method of claim 10, further comprising the steps of:
setting an optimal range of the parameter; and
controlling the hemodialysis apparatus to work within the optimal range when the parameter indicates out of the optimal range.

17. The hemodialysis method claim 10, further comprising the steps of:
storing either parameters calculated by the calculating step or changes in a time-course of the parameters; and
displaying either the parameters or the changes stored in the storing step either during another hemodialysis treatment, or before or after the hemodialysis treatment.

18. The hemodialysis method of claim 17, further comprising the step of:
transmitting the parameters stored in the storing to an external terminal.
